(19) United States
(12) Patent Application Publication
(10) Pub. No.: US 2010/0030585 A1
(43) Pub. Date: Feb. 4, 2010

(54) Insurance fulfillment system with open vendor interface

(76) Inventor: Jim Fini, Natick, MA (US)

Correspondence Address: KRISTOFER E. ELBING, 187 PELHAM ISLAND ROAD, WAYLAND, MA, 01778, US

(21) Appl. No.: 12/386,967

(22) Filed: Apr. 24, 2009

Related U.S. Application Data
(60) Provisional application No. 61/125,472, filed on Apr. 25, 2008.

(51) Int. Cl. G06Q 40/00; G06Q 30/00

(52) U.S. Cl. 705/4; 705/27

(57) ABSTRACT

An insurance fulfillment system is disclosed that includes, in one general aspect, an interactive vendor interface and storage for item listings. It also includes fulfillment management logic that is responsive to the interactive vendor interface, operative to access the storage, and responsive to a claim settlement system. A shopping access interface is operative to display aggregated item listings from different vendors and is responsive to selection commands to select items based on a claim settlement amount received from the claim settlement system.

### CROSS-REFERENCE TO RELATED APPLICATION

This application claims the benefit under 35 U.S.C. 119(e) of U.S. provisional application Ser. No. 61/125,472 filed Apr. 25, 2008 which is herein incorporated by reference.

### FIELD OF THE INVENTION

This application relates to systems that help insurance clients to replace insured items.

### BACKGROUND OF THE INVENTION

Computer-based fulfillment systems have been proposed to help in the process of replacing insured items lost to a covered peril. Some such systems are designed to allow the insurer to access listings of goods to locate suitable replacements for their clients. Others allow the clients themselves to shop for the goods through a web browser. Both types of systems have typically relied on oral negotiations, in which terms such as bulk discounts are discussed, before allowing vendors to offer goods through a fulfillment system.

### SUMMARY OF THE INVENTION

Systems according to the invention can operate in a manner that is diametrically opposed to conventional thinking, by opening up access to vendors instead of jealously guarding it. This type of open approach can result in more competition between vendors and therefore generate better prices for the insurer and/or the insurance client. It can also make a much wider range of replacement items available to the client, and may therefore result in a higher likelihood that an unusual item may be replaced. And the cost of maintaining the system may be lower than that of a conventional system, as the vendor approval process can take place automatically or be conducted by minimally trained personnel, instead of employing trained business negotiators.

In one general aspect, the invention features an insurance fulfillment system that includes an interactive vendor interface and storage for item listings. It also includes fulfillment management logic that is responsive to the interactive vendor interface, operative to access the storage, and responsive to a claim settlement system. A shopping access interface is operative to display aggregated item listings from different vendors and is responsive to selection commands to select items based on a claim settlement amount received from the claim settlement system.

In preferred embodiments, the system of the vendor interface can be fully open to any vendor. The system of the vendor interface can be fully automatic. The system in the vendor interface can include fully automatic vendor approval logic. The system of the vendor interface can be operative to apply an enforced set of minimum standards that are consistent for all vendors. The system of the vendor interface can include vendor approval logic that is operative to provide an approval indication signal anonymously. The system of the vendor interface can include vendor approval logic that is operative to provide an approval indication signal independent of any vendor-specific manual input to the fulfillment management logic. The system of the shopping access interface can be a web-based interface. The system of the vendor interface can be a web-based interface. The system of the shopping access interface can be a client interface. The system of the shopping access interface can be an adjustor interface. The system of the vendor interface can include reverse auction logic. The system of the reverse auction logic can include item aggregation logic. The system of the system can operate substantially independently of preapproval of any vendor based on substantive sales conditions. The system can further include fulfillment communication logic operative to communicate fulfillment orders to vendors via the interactive vendor interface based on selections made with the shopping access interface.

In another general aspect, the invention features an insurance fulfillment system that includes an interactive reverse auction offer interface that is operative to receive fulfillment offers for insured items to be replaced and storage for the fulfillment offers and item information. It also includes fulfillment management logic responsive to the interactive vendor interface, operative to access the storage, and responsive to a claim settlement system. A shopping access interface responsive to selection commands to select items based on a claim settlement amount received from the claim settlement system, and reverse auction logic is responsive to the shopping access interface and to the auction offer interface and having an auction award output operative to indicate at least one reverse auction winner. In preferred embodiments, the system of the reverse auction logic can include item aggregation logic.

### BRIEF DESCRIPTION OF THE DRAWINGS

FIG. 1 is a block diagram showing parts of an illustrative insurance fulfillment system according to the invention; and

FIG. 2 is a flowchart illustrating the operation of the system of FIG. 1.

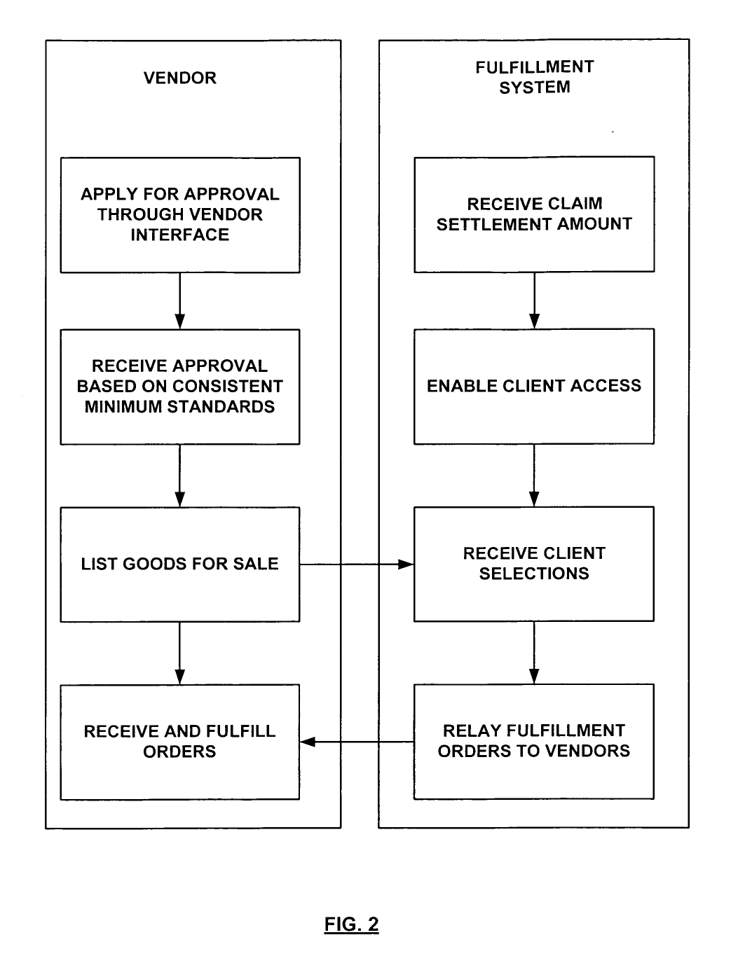

### DESCRIPTION OF AN ILLUSTRATIVE EMBODIMENT

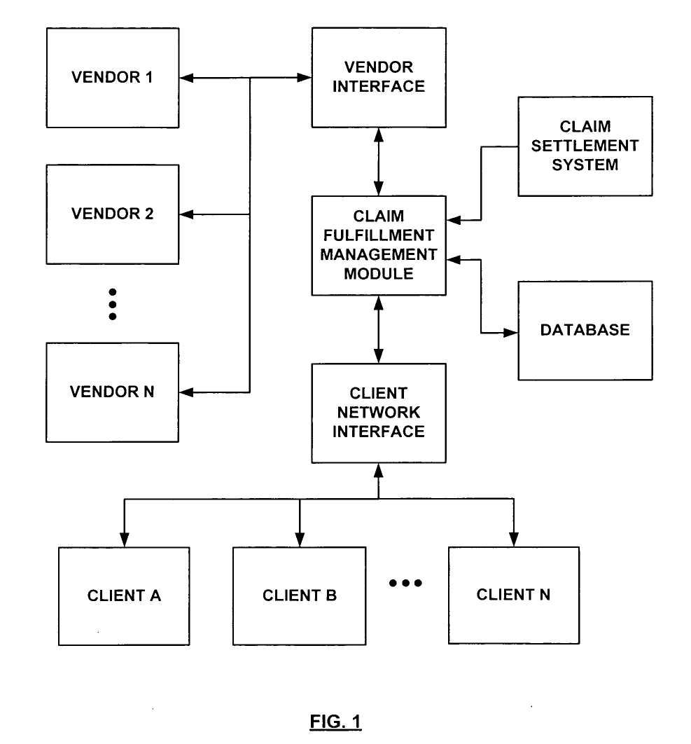

Referring to FIG. 1, an illustrative embodiment of a fulfillment system according to the invention includes a claim fulfillment management module that is operative to interact with a back-end vendor interface and a claim settlement management module. A network interface, which may include a web server, is also operative to interact with the fulfillment management module. Further included in the fulfillment system is data storage, such as a database, for use by the claim fulfillment management module.

In operation, vendors can access the vendor interface, such as by using a browser via the internet. The vendor interface provides controls, such as Hypertext Markup Language (HTML) controls, that allow a vendor to apply to list goods on the fulfillment system. Using this interface, the vendor can identify itself and indicate the types of goods that it intends to offer. The vendor can interact directly with the vendor interface or it can do so through an agent.

The vendor interface should allow any vendor to easily list goods. This can be accomplished by simply approving all vendors. It may be practically necessary, however, to deviate from this ideal by imposing some small, preferably automated, approval hurdles to weed out undesirable traffic produced by entities such as robots, hackers, and obviously fraudulent applicants.

The vendor interface can therefore provide an approval indicator that informs the vendor that it has been approved. The approval process can be fully automatic for a given vendor, and can subject vendors to approval of a minimum set of consistent standards, such as routine credit checks, corporate records checks, or fraud detection algorithms. Once the vendor receives an approval indication, the vendor can interactively list goods through the fulfillment system, which will relay orders for it to fulfill. The vendor interface should preferably provide a bulk upload interface for larger item listings.

The insurance client can also interact with the system through the internet using a browser. Before beginning the fulfillment process, however, the client generally must complete the claim settlement process. Once this process is complete, the claim settlement amount is relayed, preferably automatically, to the claim fulfillment management module, which can allow the client to access the system's fulfillment functionality.

The fulfillment system can present items for fulfillment in any of a variety of formats, such as in list views and product pages. Preferably, the client should be able to access goods from any vendor, and make his or her selection based on a competitive set of easily compared offerings. Once the client has finished shopping, the system can relay orders to the vendors for fulfillment. Payment can be relayed on any appropriate terms, and might be delayed in the case of new vendors.

The fulfillment system can also employ automated reverse auction functionality to help to optimize the price paid by the insurer or its clients. This functionality relays offers to purchase replacement goods to vendors and allows them to bid on them. The lowest bidder can then be automatically invited to fulfill the order. The offers can be for individual goods, or they can be aggregated within or across claims to invite bulk discounts.

This approach has the advantage of leveraging the demonstrated advantages of internet commerce for the benefit of the insurer and/or its clients. And because bulk discounting takes place on the back end of the system, prices can adjust to their optimal levels based on seasonal and market conditions, instead of being set through a series of individual negotiations at particular points in time, which can potentially become uncompetitive as time passes.

The fulfillment system is preferably implemented using general-purpose computer platforms running standard operating systems, such as Windows® or Linux®, that support special-purpose software to implement the functionality described above. It is also possible to create an implementation that is based on specialized custom hardware, or a combination of the two approaches. As is well known, the clients and vendors can interact with the system using standard web browsers, such as Internet Explorer or Firefox.

The various elements and steps described can be reorganized, divided, and combined in different ways without departing from the scope and spirit of the invention. For example, program logic embodied in the fulfillment management module could be incorporated into a larger claim processing system, or it could be split into different functional sub-parts. Moreover, while web-based interaction is presently contemplated as being suitable for vendors and clients, other types of interaction could also be provided, such as e-mail, or ones based on physically transported high-capacity storage media, such as optical disks. The database can range from a collection of files for smaller and/or more specialized insurers to more powerful and feature-rich databases for systems configured to process data for larger numbers of items and clients.

The present invention has now been described in connection with a number of specific embodiments thereof. However, numerous modifications which are contemplated as falling within the scope of the present invention should now be apparent to those skilled in the art. It is therefore intended that the scope of the present invention be limited only by the scope of the claims appended hereto. In addition, the order of presentation of the claims should not be construed to limit the scope of any particular term in the claims.

What is claimed is:

1. An insurance fulfillment system, comprising:
an interactive vendor interface,
storage for item listings,
fulfillment management logic responsive to the interactive vendor interface, operative to access the storage, and responsive to a claim settlement system, and
a shopping access interface operative to display aggregated item listings from a plurality of the vendors and responsive to selection commands to select items based on a claim settlement amount received from the claim settlement system.

2. The system of claim 1 wherein the vendor interface is fully open to any vendor.

3. The system of claim 1 wherein the vendor interface is fully automatic.

4. The system of claim 1 wherein the vendor interface includes fully automatic vendor approval logic.

5. The system of claim 4 wherein the vendor interface is operative to apply an enforced set of minimum standards that are consistent for all vendors.

6. The system of claim 1 wherein the vendor interface includes vendor approval logic operative to apply an enforced set of minimum standards that are consistent for all vendors.

7. The system of claim 1 wherein the vendor interface includes vendor approval logic that is operative to provide an approval indication signal anonymously.

8. The system of claim 1 wherein the vendor interface includes vendor approval logic that is operative to provide an approval indication signal independent of any vendor-specific manual input to the fulfillment management logic.

9. The system of claim 1 wherein the shopping access interface is a web-based interface.

10. The system of claim 1 wherein the vendor interface is a web-based interface.

11. The system of claim 1 wherein the shopping access interface is a client interface.

12. The system of claim 1 wherein the shopping access interface is an adjustor interface.

13. The system of claim 1 wherein the vendor interface includes reverse auction logic.

14. The system of claim 13 wherein the reverse auction logic includes item aggregation logic.

15. The system of claim 1 wherein the system operates substantially independently of preapproval of any vendor based on substantive sales conditions.

16. The system of claim 1 further including fulfillment communication logic operative to communicate fulfillment orders to vendors via the interactive vendor interface based on selections made with the shopping access interface.

17. An insurance fulfillment system, comprising:
an interactive reverse auction offer interface operative to receive fulfillment offers for insured items to be replaced,
storage for the fulfillment offers and item information,
fulfillment management logic responsive to the interactive vendor interface, operative to access the storage, and responsive to a claim settlement system,
a shopping access interface responsive to selection commands to select items based on a claim settlement amount received from the claim settlement system, and
reverse auction logic responsive to the shopping access interface and to the auction offer interface and having an auction award output operative to indicate at least one reverse auction winner.

18. The system of claim 17 wherein the reverse auction logic includes item aggregation logic.
